(19) United States
(12) Patent Application Publication
(10) Pub. No.: US 2002/0157431 A1
(43) Pub. Date: Oct. 31, 2002

(54) Lock down assembly

(76) Inventors: Alan E. Lurie, Huntington, NY (US); Hans E. R. Bosch, Lloyd Neck, NY (US)

Correspondence Address: Christopher G. Trainor, CARTER, DELUCA, FARRELL & SCHMIDT, LLP, Suite 225, 445 Broad Hollow Road, Melville, NY, 11747, US

(21) Appl. No.: 10/103,178

(22) Filed: Mar. 20, 2002

Related U.S. Application Data
(60) Provisional application No. 60/277,208, filed on Mar. 20, 2001.

(51) Int. Cl. E05B 69/00; E05B 73/00

(52) U.S. Cl. 70/58

(57) ABSTRACT

A lock down assembly is provided for securing a multi-sided three dimensional device, e.g., a laptop computer, a DVD player, a palm pilot, an MP3 player etc., to a support surface. In one preferred embodiment of the presently disclosed lock down assembly, the assembly includes a lock down member which is adapted to be secured to a support surface, at least one retention member secured to the top surface of the lock down member and a locking member which is removably secured to the top surface of the lock down member. Each retention member and the locking member is configured to prevent movement of a device supported on the lock down member in a particular direction or directions such that the combined effect of the retention member(s) and locking member is to secure a device on the top surface of the locking member. The lock down member includes a plurality of mounting bores for securing the retention member(s) and locking member at multiple locations on the lock down member. By providing multiple locations of securement, the lock down assembly can be modified to accommodate a variety of different size devices.

### BACKGROUND

This application claims priority from U.S. provisional patent application Ser. No. 60/277,208, filed Mar. 20, 2001, all of which is incorporated herein by reference.

### 1. TECHNICAL FIELD

The present disclosure relates generally to a locking assembly for securing an apparatus to be displayed to a support surface. More particularly, the present disclosure relates to a lock down assembly for fixedly securing a laptop computer, DVD player, palm pilot, MP3 player or any multi-sided three-dimensional device to a display counter or support surface.

### 2. BACKGROUND TO RELATED ART

Locking devices for securing expensive articles such as laptop computers and DVD players to a display shelf in stores are well known. Typically, such locking devices are oversized and obstruct at least a portion of the upper surface of the article. As a result, it may be difficult for a consumer to view the article without first removing the article from the locking device. Moreover, the bulkiness of the locking device may detract from the overall presentation of the article reducing the likelihood of a possible sale.

Accordingly, a need exists for an improved locking device for securing an article to a display counter which is aesthetically pleasing, unobtrusive and adjustable to receive a variety of different size articles.

### SUMMARY

In accordance with the present disclosure, a lock down assembly is provided for securing a multi-sided three dimensional device, e.g., a laptop computer, a DVD player, a palm pilot, an MP3 player etc., to a support surface. In one preferred embodiment of the presently disclosed lock down assembly, the assembly includes a lock down member which is adapted to be secured to a support surface, at least one retention member secured to the top surface of the lock down member and a locking member which is removably secured to the top surface of the lock down member. Each retention member and the locking member is configured to prevent movement of a device supported on the lock down member in a particular direction or directions such that the combined effect of the retention member(s) and locking member is to secure the device on the top surface of the locking member. The lock down member includes a plurality of mounting bores for securing the retention member(s) and locking member at multiple locations on the lock down member. By providing multiple locations of securement, the lock down assembly can be modified to accommodate a variety of different size devices.

### BRIEF DESCRIPTION OF THE DRAWINGS

Various preferred embodiments of the presently disclosed lock down assembly are now disclosed herein with reference to the drawings, wherein:

FIG. 1 is a top perspective view of one embodiment of a lock down plate of the presently disclosed lock down assembly;

FIG. 2 is a top perspective view of another preferred embodiment of the lock down plate of the presently disclosed lock down assembly;

FIG. 3 is a bottom perspective view of the locking member of the presently disclosed lock down assembly as it rests upon the top surface of the lock down plate shown in FIG. 1;

FIG. 4 is a top perspective view of the presently disclosed lock down assembly shown supporting a laptop computer;

FIG. 5 is a top perspective view of another preferred embodiment of the presently disclosed lock down assembly; and

FIG. 6 is a top perspective view of the lock down assembly shown in FIG. 5 shown supporting a palm pilot.

### DETAILED DESCRIPTION OF PREFERRED EMBODIMENTS

Preferred embodiments of the presently disclosed lock down assembly will now be described in detail with reference to the drawings in which like reference numerals designate identical or corresponding elements in each of the several views.

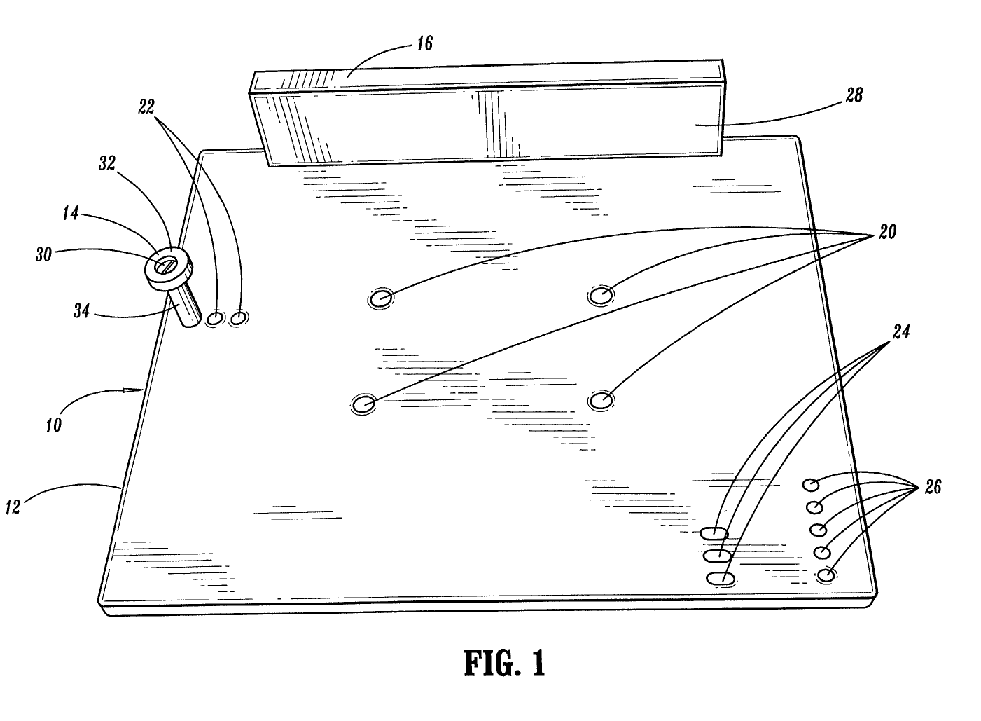

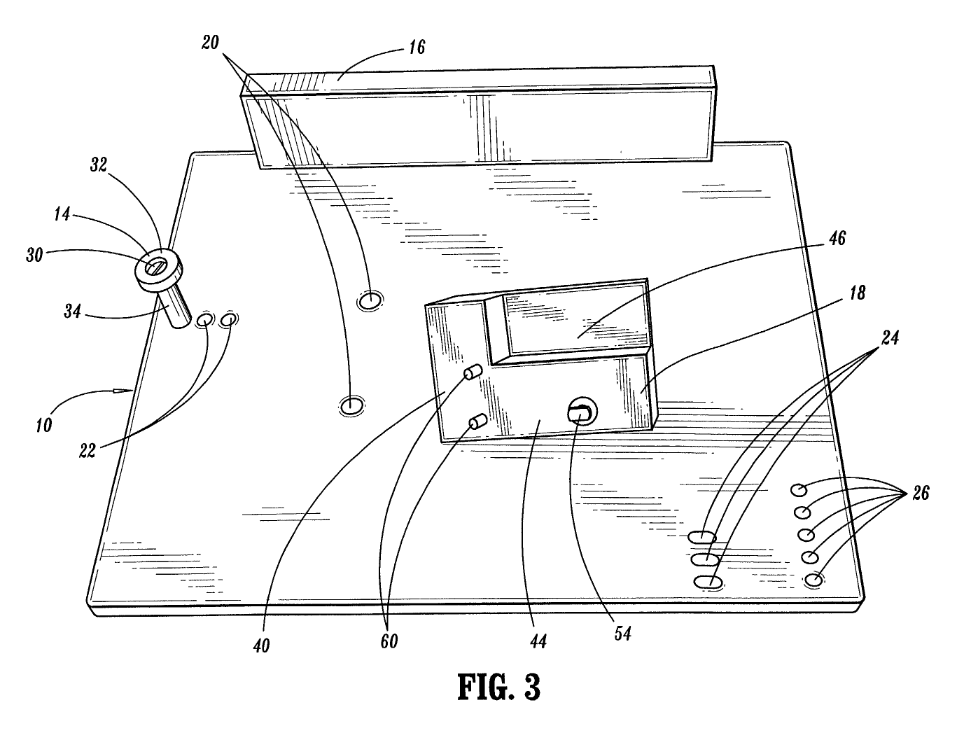

FIGS. 1-4 illustrate one embodiment of the presently disclosed lock down assembly which is shown generally as 10. Lock down assembly 10 includes a lock down plate or member 12, a retention member or mushroom collar 14, a rear wall or backup member 16, and a locking member 18 (FIG. 3). Lock down plate 12 includes a plurality of centrally located mounting throughbores 20 configured and dimensioned to threadably receive bolts (not shown) for securing lock down plate 12 to a display counter. Alternately, other known fastening devices may be used to secure plate 12 to a display counter including interlocking structure, adhesives, welding, etc.. Lock down plate 12 also includes a plurality of aligned bores 22 configured and dimensioned to receive one end of retention member 14 as will be described in detail below and a plurality of aligned elongated slots 24 and locking member bores 26.

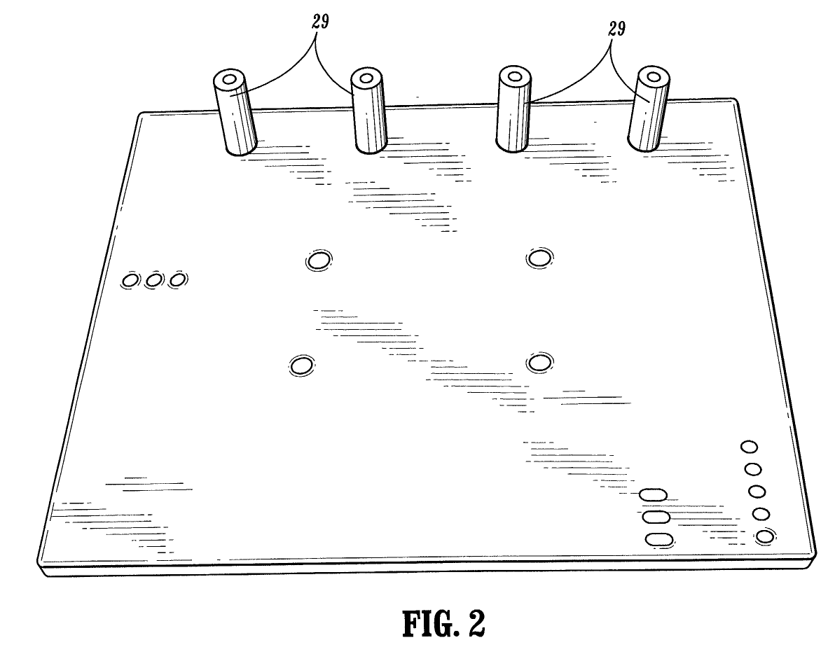

Rear wall 16 is preferably fixedly secured to locking plate 12 and positioned to define a vertical abutment surface 28. In an alternate embodiment shown in FIG. 2, a plurality of cylindrical posts may be secured to locking plate 12 in place of rear wall 16. By providing posts in place of a solid wall, access is permitted to an article secured to the lock down assembly through the space defined between the posts. Although four posts are shown, fewer or more may be provided as desired so long as they perform the required function as described below.

Retention member 14 includes a central screw member 30, a pressure fit cap 32, and a cylindrical body 34. Cap 32 and cylindrical body 34 are axially fixed but rotatable about central screw member 30. Central screw member 30 is mountable in any one of bores 22 to secure cylindrical body 34 and cap 32 at a fixed location on lock down plate 12. Screw member 30 may be a permanent screw which prevents removal of retention member 14 after it has been secured in the desired bore 22. Alternately, screw member 30 may be a removable security screw which can be removed from plate 12 to facilitate repositioning of retention member 14.

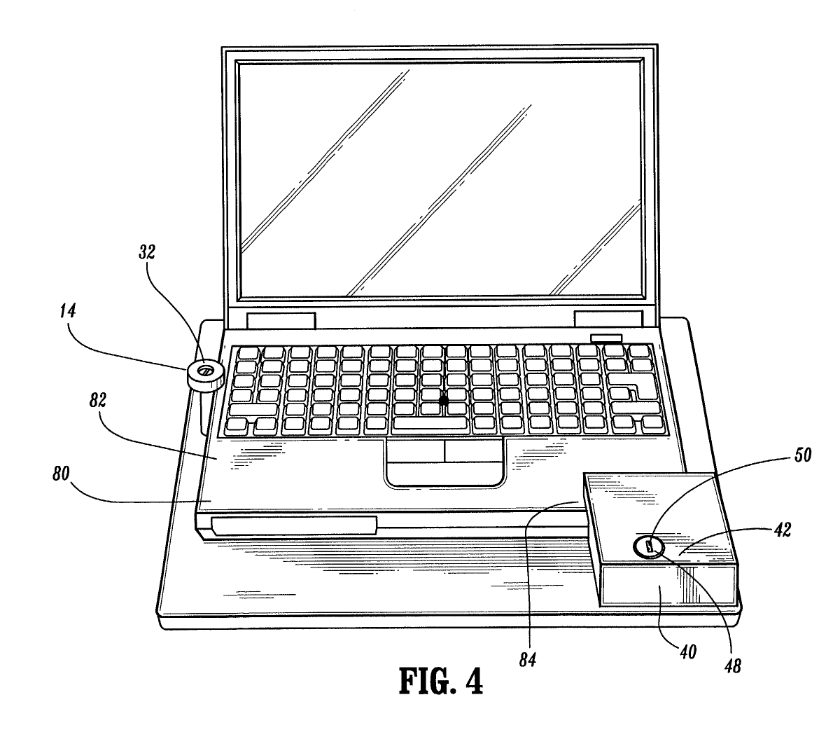

Referring to FIGS. 3 and 4, locking member 18 includes a body 40 having a top surface 42, a bottom surface 44, and a rectangular recess or cutout 46. A rotatable lock core 48 extends from the top surface 42 to the bottom surface 44 of body 40. A key slot 50 dimensioned to receive key 52 is formed in the top surface of body 40 in rotatable core 48. A rotatable engagement member 54 is secured to lock core 48 and is rotatable upon rotation of lock core 48 with key 52. Engagement member 54 is elongated and dimensioned to be received in slots 24 in a first rotation position. Engagement member 54 is rotatable to a second rotation position to prevent removal of engagement member 54 from a selected one of slots 24. Alternately, slots 24 can be replaced with a single elongated slot. A pair of pins 60 extend from bottom surface 44 of body 40 and are configured to be received in locking member bores 26. Pins 60 prevent rotation of locking member 18 about engagement member 54 after locking member 18 has been secured to locking plate 12.

Referring to FIG. 4, in use, lock down plate 18 is secured to a display counter or the like via throughbores 20 and bolts (not shown). Retention member 14 is secured to lock down plate 18 in one of collar bores 22. The collar bore 22 will be selected based on the width of lap top computer 80 or the article being secured to plate 18. It is noted that the height of cylindrical body 34 of member 14 will be selected to be slightly greater than the height of the base 82 of lap top computer 80 or similar device. After member 14 is secured to plate 12, lap top computer 80 is positioned with the top of base 82 positioned beneath cap 32 of collar 14 and the back end of base 82 positioned against rear wall 16. Next, locking member 18 is secured to plate 12 with engagement member 54 positioned in one of slots 24 and pins 60 positioned in bores 26 such that recess 46 of locking member 18 is positioned over the front corner 84 of base 82 of lap top computer 80. Thereafter, key 52 is rotated to lock engagement member 54 in slot 24. In this position, lap top computer 80 is prevented from being removed from lock down plate assembly 10.

Although the lock down plate assembly 10 was discussed for use with a lap top computer, the lock down plate assembly can be used to secure a wide variety of different articles or apparatus to a display counter including DVD players, palm pilots, MP3, etc.

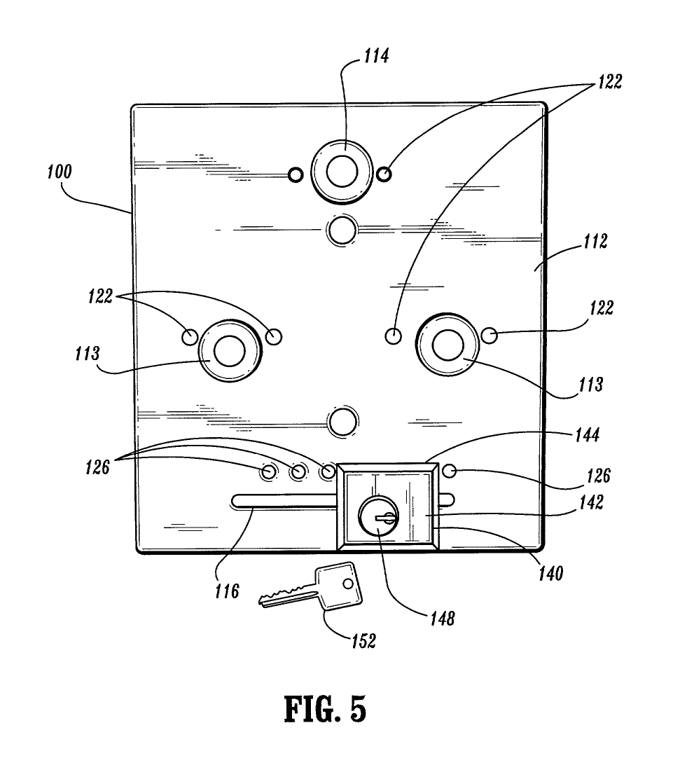

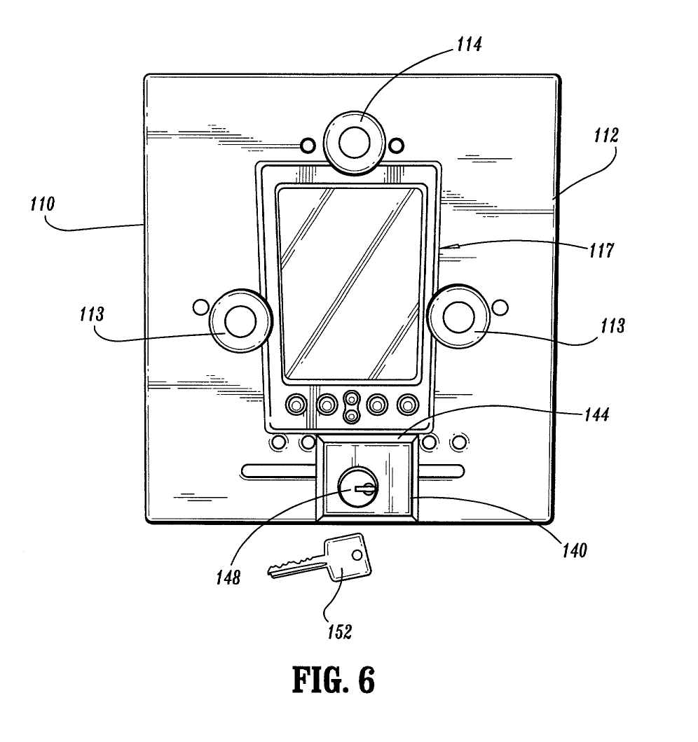

FIGS. 5 and 6 illustrate another preferred embodiment of the presently disclosed lock down plate assembly which is shown generally as 100. Lock down plate assembly 100 includes a lock down plate 112, a plurality of retention member including a pair of side members 113 and a rear member 114 and a locking member 118. Lock down plate 112 includes a plurality of bores 122 which are dimensioned to receive one end of each of retention members 113 and 114 as discussed above with respect to member 14. As illustrated, three bores 122 are provided for each retention member 113 and 114 to facilitate selective positioning of each retention member 113 and 114 on plate 112. Selective positioning of retention members 113 and 114 on plate 112 facilitates accommodation of a variety of different size articles on plate 112. Plate 112 also includes a forwardly positioned elongated slot 116 and a plurality of locking member bores 126.

Locking member 118 includes a body 140 having a top surface 142, a bottom surface (not shown) and a shoulder 144. A rotatable lock core 148 extends between top surface 142 and the bottom surface. Rotatable core 148 is similar to core 48 disclosed above and includes rotatable engagement member 154. Engagement member 154 is configured and dimensioned to pass through elongated slot 116 in a first rotation position and be lockingly engaged in elongated slot 116 in a second rotation position. A pin (not shown) projects from the bottom surface of body 140 and is dimensioned to be received in any one of bores 126. A key 152 is provided to rotate core 148 between the first and second rotation positions.

In use, plate 112 is secured to a display counter (not shown) by inserting bolts through mounting bores 120. Next, the side and rear retention members 113 and 114 are secured to a desired location of lock down plate 112. The desired location is determined by the size of the article being secured to the lock down plate assembly 100. Next, the article 117, e.g., a palm pilot, is positioned on plate 112, such that the cap 132 of each side and rear retention member 113 and 114 extends over a top surface of the apparatus. Finally, engagement member 148 is positioned through slot 116 such that the pin projecting from the bottom surface of locking member 118 is positioned in one of bores 126 and shoulder 144 is positioned over one end of the palm pilot. Key 152 can now be inserted into core 148 to rotate the engagement member to its second rotation position to lock locking member 118 to plate 112 and, thus, lock article 117 to plate 112.

It will be understood that various modifications may be made to the embodiments disclosed herein. For example, the shape of the plate need not be rectangular but rather the shape of the plate can assume a variety of different configurations including circular, square, triangular, etc. Moreover, the components, although preferably formed from metal, e.g., stainless steel, can be formed of any material having the requisite strength requirements. Further, the retention members need not be in the form of mushroom collars but rather a variety of other configurations are envisioned. Therefore, the above description should not be construed as limiting, but merely as exemplifications of preferred embodiments. Those skilled in the art will envision other modifications with the scope and spirit of the claims appended hereto.

What is claimed:

1. A lock down assembly comprising:
a lock down member adapted to be secured to a mounting surface;
at least one retention member, the at least one retention member including a body portion having a first end secured to the lock down member and a second end having a cap portion supported thereon, the body portion and cap portion defining a retention surface extending along and outwardly of the body portion; and
a locking member removably secured to the lock down member, the locking member defining a second retention surface;
wherein the at least one retention member and the locking member are positioned on the lock down member such that the first and second retention surfaces are configured to fixedly secure a multisided three dimensional device to the lock down member.

2. A lock down assembly further including a backup member fixedly secured to the lock down member.

3. A lock down assembly according to claim 1, wherein the lock down member includes a plate having a substantially planar top surface.

4. A lock down assembly according to claim 3, wherein the plate includes at least one throughbore dimensioned to receive a bolt for securing the plate to a mounting surface.

5. A lock down assembly according to claim 3, wherein the plate includes a series of retention throughbores dimensioned to receive each of the at least one retention member, each of the at least one retention members being selectively securable in any one of the series of retention throughbores to accommodate a plurality of different size devices on the lock down assembly.

6. A lock down assembly according to claim 2, wherein the backup member includes an elongated wall.

7. A lock down assembly according to claim 2, wherein the backup member includes a plurality of posts extending outwardly from a top surface of the lock down member.

8. A lock down assembly according to claim 1, wherein each retention member includes a security screw for removably securing the retention member to the lock down member.

9. A lock down assembly according to claim 1, wherein the second retention surface of the locking member is defined by a cutout configured to engage a top surface and at least one side surface of a multi-sided three-dimensional device.

10. A lock down assembly according to claim 1, wherein the at least one retention member includes three retention members secured at spaced locations on the lock down member.

11. A lock down assembly for securing a three-dimensional multi-sided device to a support structure; the assembly comprising:
a lock down member having a substantially planar top surface;
at least one retention member secured to the lock down member having a body which is positioned to prevent slidable movement of a device along the top surface of the lock down member in a first direction;
a locking member removably secured to the lock down member, the locking member including an abutment surface for preventing slidable movement of a device along the top surface of the lock down member in a second direction.

12. A lock down assembly according to claim 11, wherein the locking member includes a key operated lock for attaching and detaching the locking member to the lock down member.

13. A lock down assembly according to claim 11, wherein the at least one retention member includes first, second and third retention members secured to the lock down member at spaced locations, each of the retention members being positioned to prevent slidable movement of a device along the top surface of the lock down member in different directions.

14. A lock down assembly according to claim 11, further including a backup member secured to the lock down member and having a surface extending perpendicular to the top surface of the lock down member, the back up member preventing slidable movement of a device along the top surface of the lock down member in a third direction different from the first and second directions.

15. A lock down assembly according to claim 14, wherein the back up member includes an elongated wall.

16. A lock down assembly according to claim 14, wherein the back up member includes a plurality of posts.

17. A lock down assembly according to claim 11, wherein the lock down member includes a plurality of bores, each bore being configured and dimensioned to receive one end of a respective one of the members retention member, at least one of the retention members being capable of securement to the lock down member at multiple locations such that the lock down assembly is capable of accommodating multiple size three-dimensional devices.

18. A lock down assembly according to claim 17, wherein the lock down member includes a plurality of bores configured and dimensioned lockingly receive the locking member such that the locking member is capable of securement to the lock down member at multiple locations.

19. A lock down assembly according to claim 11, wherein each retention member includes a retention surface which extends radially from the body and is dimensioned to prevent movement of a device supported on the top surface of the lock down member from movement in a direction perpendicular to the plane defined by the top surface of the lock down member.

20. A lock down assembly according to claim 11, wherein the locking member is configured to engage two sides and a top surface of a device supported on the planar top surface of the lock down member.
